(19) United States
(12) Patent Application Publication
(10) Pub. No.: US 2025/0166521 A1
(43) Pub. Date: May 22, 2025

(54) PERSONALIZED INTERACTIVE LEARNING SKILLS MAP

(71) Applicant: Pearson Education, Inc., Bloomington, MN (US)

(72) Inventors: Elizabeth GRAHAM-MEREDITH, Bloomington, MN (US); Douglas Vincent ODELL, III, Bloomington, MN (US); Christopher John SCHUTT, Bloomington, MN (US); John SADUASKAS, Bloomington, MN (US); Michael PACE, Bloomington, MN (US)

(21) Appl. No.: 18/832,861

(22) PCT Filed: Feb. 3, 2023
(86) PCT No.: PCT/US2023/061892

§ 371 Date: Jul. 24, 2024

Related U.S. Application Data
(60) Provisional application No. 63/306,724, filed on Feb. 4, 2022.

(51) Int. Cl. G09B 5/06

(52) U.S. Cl. CPC G09B 5/065

(57) ABSTRACT

Systems and methods of the present invention for constructing an interactive skills map on a graphical user interface include: determining a first skill of a user; displaying the first skill on the graphical user interface; displaying one or more first possible skills adjacent to the first skill, the one or more first possible skills related to the first skill, wherein the one or more first possible skills are inactivated; receiving a first user input to select a possible skill among the one or more first possible skills on the graphical user interface; activating the selected possible skill among the one or more first possible skills to be a second skill; and in response to the first user input, dynamically displaying one or more second possible skills adjacent to the second skill, the one or more second possible skills related to the second skill.

### CROSS-REFERENCE TO RELATED APPLICATIONS

This application claims priority to U.S. Provisional Application No. 63/306,724, filed on Feb. 4, 2022, which is hereby incorporated by reference in its entirety.

### TECHNICAL FIELD

This disclosure relates to the field of systems and methods configured to construct an interactive and dynamic graphical user interface to maximize learning potential.

### SUMMARY

The disclosed technology relates to systems and methods including one or more server hardware computing devices or client hardware computing devices, communicatively coupled to a network, and each including at least one processor executing specific computer-executable instructions within a memory that, when executed, cause the system to: determine a first skill of a user; display the first skill on the graphical user interface; display one or more first possible skills adjacent to the first skill. The one or more first possible skills are related to the first skill. The one or more first possible skills are inactivated. The systems and methods also receive a first user input to select a possible skill among the one or more first possible skills on the graphical user interface; activate the selected possible skill among the one or more first possible skills to be a second skill; and in response to the first user input, dynamically display one or more second possible skills adjacent to the second skill. The one or more second possible skills are related to the second skill.

The above features and advantages of the present invention will be better understood from the following detailed description taken in conjunction with the accompanying drawings.

### BRIEF DESCRIPTION OF THE DRAWINGS

FIG. 1 illustrates a system level block diagram for providing the disclosed plugin system and pathway architecture.

FIG. 2 illustrates a system level block diagram for providing the disclosed plugin system and pathway architecture, in accordance with various aspects of the techniques described in this disclosure.

FIG. 3 illustrates a system level block diagram of a skill management system that facilitates the disclosed plugin system and pathway architecture, in accordance with various aspects of the techniques described in this disclosure.

FIG. 4 is a schematic diagram conceptually illustrating an example screen of a graphical user interface (GUI) for displaying skill families, in accordance with various aspects of the techniques described in this disclosure.

FIG. 5 is a schematic diagram conceptually illustrating an example screen of a GUI for displaying a user profile, in accordance with various aspects of the techniques described in this disclosure.

FIG. 6 is a schematic diagram conceptually illustrating an example screen of a graphical user interface (GUI) for displaying a user plan, in accordance with various aspects of the techniques described in this disclosure.

FIG. 7 is a flowchart illustrating an example method and technique for constructing an interactive and dynamic skills map, in accordance with various aspects of the techniques described in this disclosure.

FIG. 8 is a schematic diagram conceptually illustrating an example screen of a GUI for constructing a skills map, which is personalized and customized to the user, in accordance with various aspects of the techniques described in this disclosure.

FIG. 9 is a schematic diagram conceptually illustrating a further example screen of a GUI for constructing a skills map, which is personalized and customized to the user, in accordance with various aspects of the technique described in this disclosure.

FIG. 10 is a schematic diagram conceptually illustrating a further example screen of a GUI for constructing a skills map, which is personalized and customized to the user, in accordance with various aspects of the technique described in this disclosure.

FIG. 11 is a schematic diagram conceptually illustrating a further example screen of a GUI for constructing a skills map, which is personalized and customized to the user, in accordance with various aspects of the technique described in this disclosure.

FIG. 12 is a schematic diagram conceptually illustrating an example screen of a GUI for displaying a magnified skills map, in accordance with various aspects of the technique described in this disclosure.

FIG. 13 is a schematic diagram conceptually illustrating an example screen of a GUI for displaying a skills map with a progress bar, in accordance with various aspects of the technique described in this disclosure.

FIG. 14 is a schematic diagram conceptually illustrating a further example screen of a GUI for displaying a skills map with a progress bar, in accordance with various aspects of the technique described in this disclosure.

FIG. 15 is a schematic diagram conceptually illustrating an example screen of a GUI for displaying a learning course content, in accordance with various aspects of the technique described in this disclosure.

### DETAILED DESCRIPTION

The disclosed technology will now be discussed in detail with regard to the attached drawing figures that were briefly described above. In the following description, numerous specific details are set forth illustrating the Applicant's best mode for practicing the invention and enabling one of ordinary skill in the art to make and use the invention. One skilled in the art will recognize that embodiments of the present invention may be practiced without many of these specific details. In other instances, well-known machines, structures, and method steps have not been described in particular detail in order to avoid unnecessarily obscuring embodiments of the present invention. Unless otherwise indicated, like parts and method steps are referred to with like reference numerals.

In online learning environments in which users are presented with learning information, the users may search contents to study and learn. However, the users spend their time to acquire knowledge and skills through the contents without a personalized guide. Additionally, the options available to a user may be displayed in a cluttered or unsystematic way, making use of the information overwhelming and difficult for the user. Further, the user may use a separate site to explore jobs and skills associated with the jobs and find relevant contents to acquire the skills. In such examples, systems for the users are not able to effectively provide a learning pathway or plan to provide learning contents for jobs, in which the user is interested. In other words, the systems are unable to effectively capture user's already acquired skills and provide career and learning pathways, which are customized and personalized to the users.

The disclosed systems and methods include constructing and revising a skills map on a graphical user interface (GUI) for providing an interactive and dynamic skills map customized to the user on a GUI based on stored feature data and data from other research. Further, embodiments of the disclosed systems and methods provide improved user interfaces and efficiencies for client devices. For example, the systems and methods provide an effective and efficient GUI by interactively and dynamically constructing skills maps on the GUI, which are personalized and customized to users. Thus, the systems and methods can provide efficient and effective personal career and learning pathways using interactive skills maps. Also, the systems and methods can guide the users to the right content to build the right sills for the right career pathways, informed by global data and employer preferences. In addition, the systems and methods provide an efficient GUI to find right skills associated with skill families and jobs based on user-acquired skills or preferences.

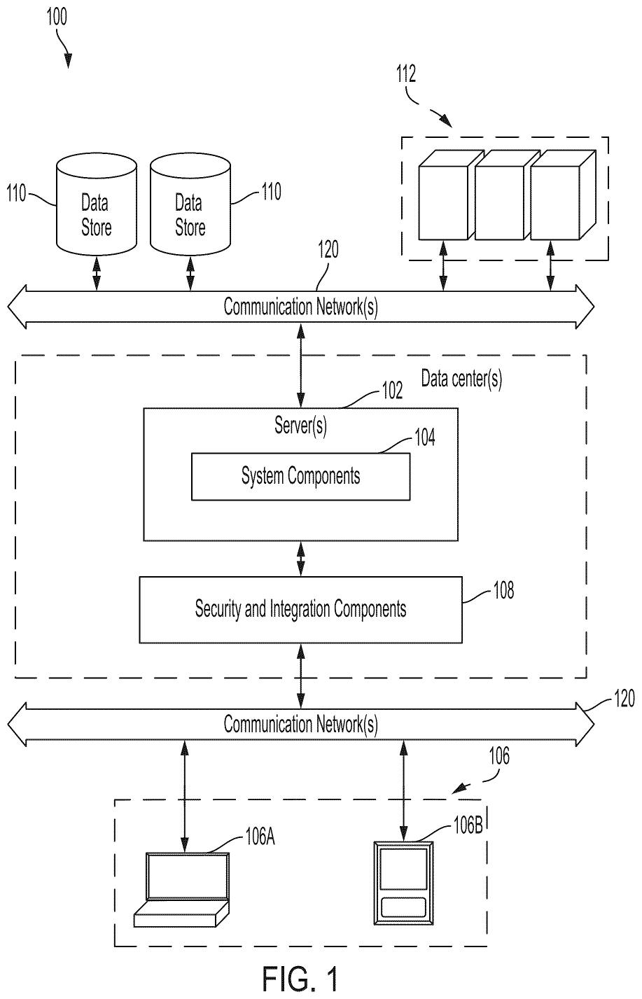

FIG. 1 illustrates a non-limiting example of a distributed computing environment 100. In some examples, the distributed computing environment 100 may include one or more server(s) 102 (e.g., data servers, computing devices, computers, etc.), one or more client computing devices 106, and other components that may implement certain embodiments and features described herein. Other devices, such as specialized sensor devices, etc., may interact with the client computing device(s) 106 and/or the server(s) 102. The server(s) 102, client computing device(s) 106, or any other devices may be configured to implement a client-server model or any other distributed computing architecture. In an illustrative and non-limiting example, the client devices 106 may include a first client device 106A and a second client device 106B. The first client device 106A may correspond to a first learner user in a class and the second client device 106B may correspond to a second learner user in the class or another class.

In some examples, the server(s) 102, the client computing device(s) 106, and any other disclosed devices may be communicatively coupled via one or more communication network(s) 120. The communication network(s) 120 may be any type of network known in the art supporting data communications. As non-limiting examples, network 120 may be a local area network (LAN; e.g., Ethernet, Token-Ring, etc.), a wide-area network (e.g., the Internet), an infrared or wireless network, a public switched telephone networks (PSTNs), a virtual network, etc. Network 120 may use any available protocols, such as, e.g., transmission control protocol/Internet protocol (TCP/IP), systems network architecture (SNA), Internet packet exchange (IPX), Secure Sockets Layer (SSL), Transport Layer Security (TLS), Hypertext Transfer Protocol (HTTP), Secure Hypertext Transfer Protocol (HTTPS), Institute of Electrical and Electronics (IEEE) 802.11 protocol suite or other wireless protocols, and the like.

The embodiments shown in FIGS. 1 and/or 2 are one example of a distributed computing system and are not intended to be limiting. The subsystems and components within the server(s) 102 and the client computing device(s) 106 may be implemented in hardware, firmware, software, or combinations thereof. Various different subsystems and/or components 104 may be implemented on server 102. Users operating the client computing device(s) 106 may initiate one or more client applications to use services provided by these subsystems and components. Various different system configurations are possible in different distributed computing environments 100 and content distribution networks. Server 102 may be configured to run one or more server software applications or services, for example, web-based or cloud-based services, to support content distribution and interaction with client computing device(s) 106. Users operating client computing device(s) 106 may in turn utilize one or more client applications (e.g., virtual client applications) to interact with server 102 to utilize the services provided by these components. The client computing device(s) 106 may be configured to receive and execute client applications over the communication network(s) 120. Such client applications may be web browser-based applications and/or standalone software applications, such as mobile device applications. The client computing device(s) 106 may receive client applications from server 102 or from other application providers (e.g., public or private application stores).

As shown in FIG. 1, various security and integration components 108 may be used to manage communications over the communication network(s) 120 (e.g., a file-based integration scheme, a service-based integration scheme, etc.). In some examples, the security and integration components 108 may implement various security features for data transmission and storage, such as authenticating users or restricting access to unknown or unauthorized users. As non-limiting examples, the security and integration components 108 may include dedicated hardware, specialized networking components, and/or software (e.g., web servers, authentication servers, firewalls, routers, gateways, load balancers, etc.) within one or more data centers in one or more physical location(s) and/or operated by one or more entities, and/or may be operated within a cloud infrastructure. In various implementations, the security and integration components 108 may transmit data between the various devices in the distribution computing environment 100 (e.g., in a content distribution system or network). In some examples, the security and integration components 108 may use secure data transmission protocols and/or encryption (e.g., File Transfer Protocol (FTP), Secure File Transfer Protocol (SFTP), and/or Pretty Good Privacy (PGP) encryption) for data transfers, etc.).

In some examples, the security and integration components 108 may implement one or more web services (e.g., cross-domain and/or cross-platform web services) within the distribution computing environment 100, and may be developed for enterprise use in accordance with various web service standards (e.g., the Web Service Interoperability (WS-I) guidelines). In an example, some web services may provide secure connections, authentication, and/or confidentiality throughout the network using technologies such as SSL, TLS, HTTP, HTTPS, WS-Security standard (providing secure SOAP messages using XML encryption), etc. In some examples, the security and integration components 108 may include specialized hardware, network appliances, and the like (e.g., hardware-accelerated SSL and HTTPS), possibly installed and configured between one or more server(s) 102 and other network components. In such examples, the security and integration components 108 may thus provide secure web services, thereby allowing any external devices to communicate directly with the specialized hardware, network appliances, etc.

A distribution computing environment 100 may further include one or more data stores 110. In some examples, the one or more data stores 110 may include, and/or reside on, one or more back-end servers 112, operating in one or more data center(s) in one or more physical locations. In such examples, the one or more data stores 110 may communicate data between one or more devices, such as those connected via the one or more communication network(s) 120. In some cases, the one or more data stores 110 may reside on a non-transitory storage medium within one or more server(s) 102. In some examples, data stores 110 and back-end servers 112 may reside in a storage-area network (SAN). In addition, access to one or more data stores 110, in some examples, may be limited and/or denied based on the processes, user credentials, and/or devices attempting to interact with the one or more data stores 110.

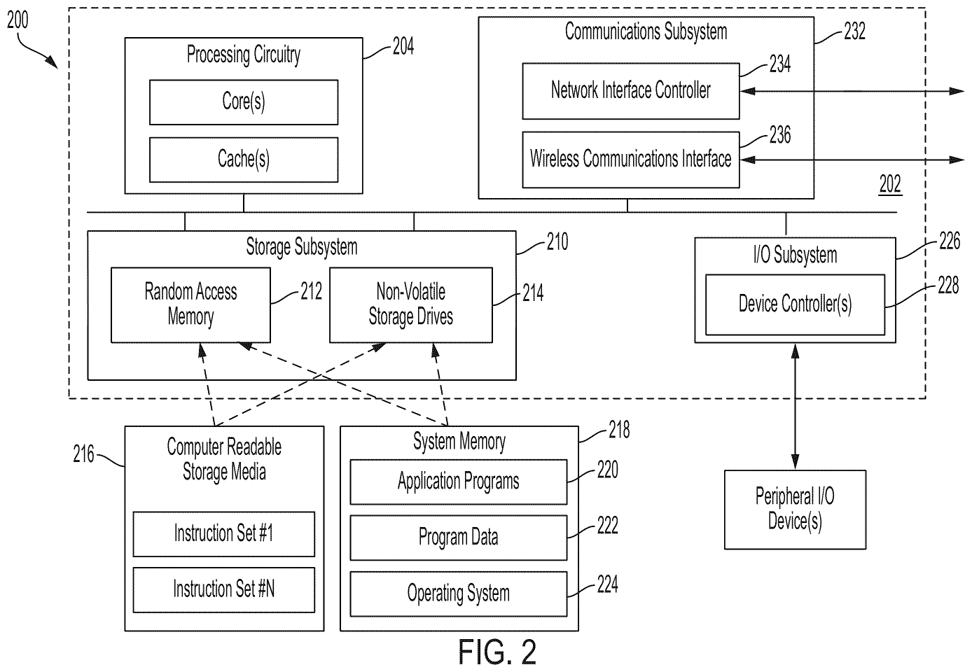

With reference now to FIG. 2, a block diagram of an example computing system 200 is shown. The computing system 200 (e.g., one or more computers) may correspond to any one or more of the computing devices or servers of the distribution computing environment 100, or any other computing devices described herein. In an example, the computing system 200 may represent an example of one or more server(s) 102 and/or of one or more server(s) 112 of the distribution computing environment 100. In another example, the computing system 200 may represent an example of the client computing device(s) 106 of the distribution computing environment 100. In some examples, the computing system 200 may represent a combination of one or more computing devices and/or servers of the distribution computing environment 100.

In some examples, the computing system 200 may include processing circuitry 204, such as one or more processing unit(s), processor(s), etc. In some examples, the processing circuitry 204 may communicate (e.g., interface) with a number of peripheral subsystems via a bus subsystem 202. These peripheral subsystems may include, for example, a storage subsystem 210, an input/output (I/O) subsystem 226, and a communications subsystem 232.

In some examples, the processing circuitry 204 may be implemented as one or more integrated circuits (e.g., a conventional micro-processor or microcontroller). In an example, the processing circuitry 204 may control the operation of the computing system 200. The processing circuitry 204 may include single core and/or multicore (e.g., quad core, hexa-core, octo-core, ten-core, etc.) processors and processor caches. The processing circuitry 204 may execute a variety of resident software processes embodied in program code, and may maintain multiple concurrently executing programs or processes. In some examples, the processing circuitry 204 may include one or more specialized processors, (e.g., digital signal processors (DSPs), outboard, graphics application-specific, and/or other processors).

In some examples, the bus subsystem 202 provides a mechanism for intended communication between the various components and subsystems of computing system 200. Although the bus subsystem 202 is shown schematically as a single bus, alternative embodiments of the bus subsystem may utilize multiple buses. In some examples, the bus subsystem 202 may include a memory bus, memory controller, peripheral bus, and/or local bus using any of a variety of bus architectures (e.g., Industry Standard Architecture (ISA), Micro Channel Architecture (MCA), Enhanced ISA (EISA), Video Electronics Standards Association (VESA), and/or Peripheral Component Interconnect (PCI) bus, possibly implemented as a Mezzanine bus manufactured to the IEEE P1386.1 standard).

In some examples, the I/O subsystem 226 may include one or more device controller(s) 228 for one or more user interface input devices and/or user interface output devices, possibly integrated with the computing system 200 (e.g., integrated audio/video systems, and/or touchscreen displays), or may be separate peripheral devices which are attachable/detachable from the computing system 200. Input may include keyboard or mouse input, audio input (e.g., spoken commands), motion sensing, gesture recognition (e.g., eye gestures), etc. As non-limiting examples, input devices may include a keyboard, pointing devices (e.g., mouse, trackball, and associated input), touchpads, touch screens, scroll wheels, click wheels, dials, buttons, switches, keypad, audio input devices, voice command recognition systems, microphones, three dimensional (3D) mice, joysticks, pointing sticks, gamepads, graphic tablets, speakers, digital cameras, digital camcorders, portable media players, webcams, image scanners, fingerprint scanners, barcode readers, 3D scanners, 3D printers, laser rangefinders, eye gaze tracking devices, medical imaging input devices, MIDI keyboards, digital musical instruments, and the like. In general, use of the term “output device” is intended to include all possible types of devices and mechanisms for outputting information from computing system 200, such as to a user (e.g., via a display device) or any other computing system, such as a second computing system 200. In an example, output devices may include one or more display subsystems and/or display devices that visually convey text, graphics and audio/video information (e.g., cathode ray tube (CRT) displays, flat-panel devices, liquid crystal display (LCD) or plasma display devices, projection devices, touch screens, etc.), and/or may include one or more non-visual display subsystems and/or non-visual display devices, such as audio output devices, etc. As non-limiting examples, output devices may include, indicator lights, monitors, printers, speakers, headphones, automotive navigation systems, plotters, voice output devices, modems, etc.

In some examples, the computing system 200 may include one or more storage subsystems 210, including hardware and software components used for storing data and program instructions, such as system memory 218 and computer-readable storage media 216. In some examples, the system memory 218 and/or the computer-readable storage media 216 may store and/or include program instructions that are loadable and executable on the processor(s) 204. In an example, the system memory 218 may load and/or execute an operating system 224, program data 222, server applications, application program(s) 220 (e.g., client applications), Internet browsers, mid-tier applications, etc. In some examples, the system memory 218 may further store data generated during execution of these instructions.

In some examples, the system memory 218 may be stored in volatile memory (e.g., random-access memory (RAM) 212, including static random-access memory (SRAM) or dynamic random-access memory (DRAM)). In an example, the RAM 212 may contain data and/or program modules that are immediately accessible to and/or operated and executed by the processing circuitry 204. In some examples, the system memory 218 may also be stored in non-volatile storage drives 214 (e.g., read-only memory (ROM), flash memory, etc.). In an example, a basic input/output system (BIOS), containing the basic routines that help to transfer information between elements within the computing system 200 (e.g., during start-up), may typically be stored in the non-volatile storage drives 214.

In some examples, the storage subsystem 210 may include one or more tangible computer-readable storage media 216 for storing the basic programming and data constructs that provide the functionality of some embodiments. In an example, the storage subsystem 210 may include software, programs, code modules, instructions, etc., that may be executed by the processing circuitry 204, in order to provide the functionality described herein. In some examples, data generated from the executed software, programs, code, modules, or instructions may be stored within a data storage repository within the storage subsystem 210. In some examples, the storage subsystem 210 may also include a computer-readable storage media reader connected to the computer-readable storage media 216.

In some examples, the computer-readable storage media 216 may contain program code, or portions of program code. Together and, optionally, in combination with the system memory 218, the computer-readable storage media 216 may comprehensively represent remote, local, fixed, and/or removable storage devices plus storage media for temporarily and/or more permanently containing, storing, transmitting, and/or retrieving computer-readable information. In some examples, the computer-readable storage media 216 may include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer-readable media. This can also include nontangible computer-readable media, such as data signals, data transmissions, or any other medium which can be used to transmit the desired information and which can be accessed by the computing system 200. In an illustrative and non-limiting example, the computer-readable storage media 216 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media.

In some examples, the computer-readable storage media 216 may include, but is not limited to, Zip® drives, flash memory cards, universal serial bus (USB) flash drives, secure digital (SD) cards, DVD disks, digital video tape, and the like. In some examples, the computer-readable storage media 216 may include, solid-state drives (SSD) based on non-volatile memory such as flash-memory based SSDs, enterprise flash drives, solid state ROM, and the like, SSDs based on volatile memory such as solid-state RAM, dynamic RAM, static RAM, DRAM-based SSDs, magneto-resistive RAM (MRAM) SSDs, and hybrid SSDs that use a combination of DRAM and flash memory-based SSDs. The disk drives and their associated computer-readable media may provide non-volatile storage of computer-readable instructions, data structures, program modules, and other data for the computing system 200.

In some examples, the communications subsystem 232 may provide a communication interface from the computing system 200 and external computing devices via one or more communication networks, including local area networks (LANs), wide area networks (WANs) (e.g., the Internet), and various wireless telecommunications networks. As illustrated in FIG. 2, the communications subsystem 232 may include, for example, one or more network interface controllers (NICs) 234, such as Ethernet cards, Asynchronous Transfer Mode NICs, Token Ring NICs, and the like, as well as one or more wireless communications interfaces 236, such as wireless network interface controllers (WNICs), wireless network adapters, and the like. Additionally, and/or alternatively, the communications subsystem 232 may include one or more modems (telephone, satellite, cable, ISDN), synchronous or asynchronous digital subscriber line (DSL) units, Fire Wire® interfaces, USB® interfaces, and the like. Communications subsystem 232 also may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.11 family standards, or other mobile communication technologies, or any combination thereof), global positioning system (GPS) receiver components, and/or other components.

In some examples, the communications subsystem 232 may also receive input communication in the form of structured and/or unstructured data feeds, event streams, event updates, and the like, on behalf of one or more users who may use or access the computing system 200. In an example, the communications subsystem 232 may be configured to receive data feeds in real-time from users of social networks and/or other communication services, web feeds such as Rich Site Summary (RSS) feeds, and/or real-time updates from one or more third party information sources (e.g., data aggregators). Additionally, the communications subsystem 232 may be configured to receive data in the form of continuous data streams, which may include event streams of real-time events and/or event updates (e.g., sensor data applications, financial tickers, network performance measuring tools, clickstream analysis tools, automobile traffic monitoring, etc.). In some examples, the communications subsystem 232 may output such structured and/or unstructured data feeds, event streams, event updates, and the like to one or more data stores that may be in communication with one or more streaming data source computing systems (e.g., one or more data source computers, etc.) coupled to the computing system 200. The various physical components of the communications subsystem 232 may be detachable components coupled to the computing system 200 via a computer network (e.g., a communication network 120), a FireWire® bus, or the like, and/or may be physically integrated onto a motherboard of the computing system 200. In some examples, the communications subsystem 232 may be implemented in whole or in part by software.

Due to the ever-changing nature of computers and networks, the description of the computing system 200 depicted in the figure is intended only as a specific example. Many other configurations having more or fewer components than the system depicted in the figure are possible. For example, customized hardware might also be used and/or particular elements might be implemented in hardware, firmware, software, or a combination. Further, connection to other computing devices, such as network input/output devices, may be employed. Based on the disclosure and teachings provided herein, a person of ordinary skill in the art will appreciate other ways and/or methods to implement the various embodiments.

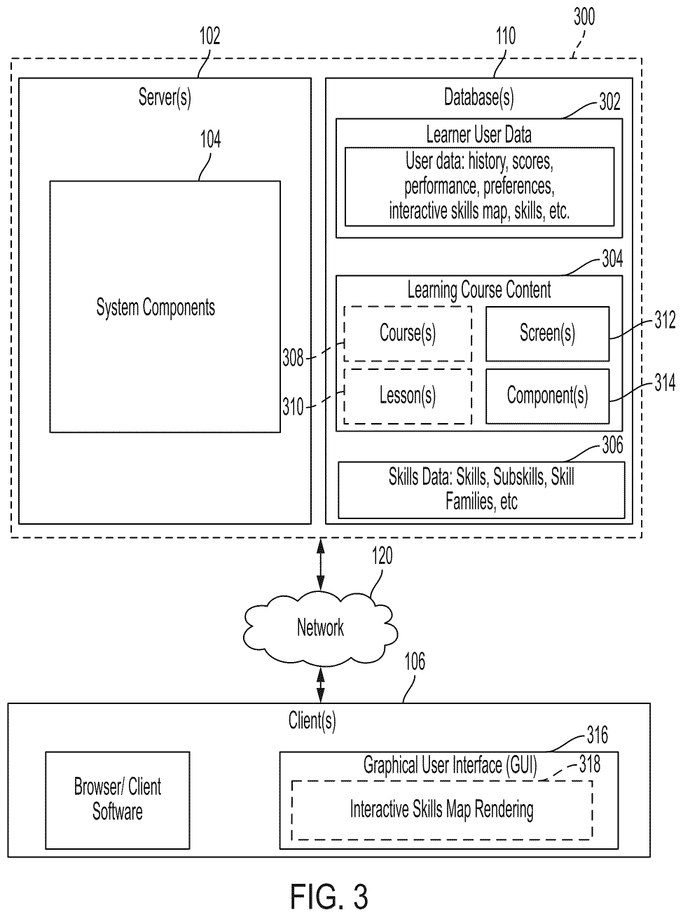

FIG. 3 illustrates a system level block diagram of an interactive digital learning platform system 300, such as a skill management system for providing the disclosed learning course content and managing annotations from users according to some examples. In some examples, the interactive digital learning platform system 300 may include one or more database(s) 110, also referred to as data stores herein. The database(s) 110 may include a plurality of user data 302 (e.g., a set of learner user data items). In such examples, the interactive digital learning platform system 300 may store and/or manage the user data in accordance with one or more of the various techniques of the disclosure. In some examples, the user data may include user responses, user history, user scores, user performance, user preferences, user acquired skills, activated skills to acquire, interactive skills maps, and the like.

In some examples, the system 300 may utilize the user data to make decisions (e.g., as part of a decision tree algorithm), and in some examples, the interactive digital learning platform system 300 may construct a skills map for a particular user (e.g., a learner user). In an illustrative example, the interactive digital learning platform system 300 may utilize the user data to construct and/or revise a skills map of a learner user based on user data stored in the database 110 that corresponds to that learner user and interactions with the user. In some examples, the user data may be received by one or more users, for example, using a client computing device 106 operated by one or more learner users.

In addition, the database(s) 110 may include skills data 306. The skills data may include skills, subskills, and/or skill families. In some examples, a skill family may include one or more skills. Thus, when all of skills in the skill family are completed, the server 102 can indicate that the user acquires the skill family. In some examples, a skill can be included in more than one skill family. In addition, a skill may include one or more subskills. Similarly, when all of subskills in the skill are completed, the server 102 can indicate that the user acquires the skill. In some examples, a subskill can be included in more than one skill. Alternatively, a skill may include one or more learning course contents. Similarly, when all of learning course contents in the skill are completed, the server 102 can indicate that the user acquires the skill. In some examples, a learning course content can be included in more than one skill.

A skill family may be a group of skills that indicates competencies to perform certain tasks in a job. In some examples, a skill family (e.g., UX design, UI design, data analysis, etc.) may be associated with a job type. In the examples, multiple skill families may be associated with a job type. In a non-limiting scenario, a certain job may require one or more skill families. In other examples, a skill family (e.g., basic writing skills) may be associated with a general expertise for all workers. In some examples, the server 102 may display how many skills in a skill family a user completes. When all skills in a skill family are completed, the server 102 may display that the user acquires the skill family.

In some instances, a skill in a skill family may be an indication of an ability to perform a task. A skill may include a certificate, a degree, a credential, a diploma, a license, a document, an experience, or any indication that the user is able to perform a task. For example, the UX design skill family may include multiple skills for the skill family (e.g., typography, photography & illustration, presentation skills, etc.). In other examples, the basic skills may include multiple skills (e.g., networking, resume, business etiquette, business writing, etc.). In further examples, a skill may be included in multiple skill families. For example, although UX design skill family and UI design skill family are different skill families, each of both skill families may include one or more of the same skills (e.g., photography & illustration, presentation skills, etc.). Skill families more closely related to each other may share more skills than other skill families less related to the skill families. In further examples, a skill may include one or more subskills. In the examples, the server 102 may display how many subskills in a skill a user completes. In some examples, a subskill may be included in multiple skills. When all subskills in a skill are completed, the server may display that the user acquires the skill. In some scenarios, a skill or a subskill may include one or more learning course contents 304 associated with the skill or the subskill. In some scenarios, a skill may include one or more learning course contents 304. When one or more learning course contents 304 of a skill are completed, the server 102 may issue a certificate, a degree, a credential, a diploma, a license, or a document indicating that the user acquired the skill.

In some examples, a learning course content 304 may include an e-book (electronic version of a printed book), a document, a video, a practice exam, a flashcard, courseware elements (e.g., courses, units, assessments, lessons, etc.), an online/offline internship, 3^{rd} party education content, or any other suitable format of learning content in various examples. In further examples, the interactive digital learning platform system 300 may organize the courseware elements of the learning course content 304 in a hierarchy. In an example, the hierarchy may include structured data for creating one or more element(s) of the courseware architecture. In an example, a top level of the courseware architecture may include courses, a mid-level may include units, and a lower level may include lessons. When a user via a client device 106 completes all of the one or more learning course contents 304, the server 102 may display to the client device 106 that the user acquires the skill or the subskill. In some examples, the server 102 may issue a certificate or a degree. In some examples, a learning course content 304 may be included in multiple skills or multiple subskills. When a learning course content 304 is in an online learning content, the server 102 may mark completion of the learning course content 304 upon finishing the online learning content (e.g., reading a whole e-book or document, watching a whole video, finishing a practice exam, etc.). In other examples, when a learning course content 304 is an offline learning content (e.g., offline internship) or a 3^{rd} party education content, the server 102 may receive a completion indication of the online learning content or the 3^{rd} party education content from the relevant party. Alternatively, the user via the client device 106 may provide the completion indication to the server 102 (e.g., by clicking a button indicating completion of the learning content).

In some examples, ‘courses’ may include one or more high-level collection(s) of ‘units.’ In some examples, the interactive digital learning platform system 300 may generate a suggested order of units that learner users should follow. In some examples, the skill management system 300 may present the suggested order of units to a content creator.

In some examples, ‘units,’ also referred to as modules, may include a grouping of ‘lessons’ and/or ‘assessments.’ As with ‘courses’ above, the skill management system 300 may generate a suggested or recommended order of lessons and assessments. In some examples, the skill management system 300 may present the recommended order of lessons and assessments to a content creator.

In addition, ‘lessons’ may each include a set of digital screens (herein “screens”) designed in a specific way in order to teach a learner user one or more objectives. In an example, a ‘lesson’ may include a set of screens designed with targeted feedback in order to teach the learner user the one or more objectives. In some examples, the feedback may include adaptive feedback responsive to one or more interaction(s) of a learner user. ‘Assessments’ may include a set of screens designed in a specific way to assess the learner user's ability to meet one or more learning objectives. In some examples, these ‘assessments’ may include any combination of question types (e.g., true/false, multiple choice, essay, etc.). In addition, it is often the case that a ‘lesson’ may also be performing ‘assessment’ operations at the same time, and vice-versa. As such, the lines between ‘lessons’ and ‘assessments’ are often blurred. With this in mind, in some examples, ‘lessons’ and ‘assessments’ may include quiz features and/or functionality allowing learner users to navigate a set of questions in any combination of orders.

In addition, the database(s) 110 may further include user-specific skills maps 302 for users. In an illustrative and non-limiting example, a skills map may include one or more user-acquired skills, potential and activated skills to acquire, possible skills that are associated with the user acquired skills and/or potential skills but have not been activated.

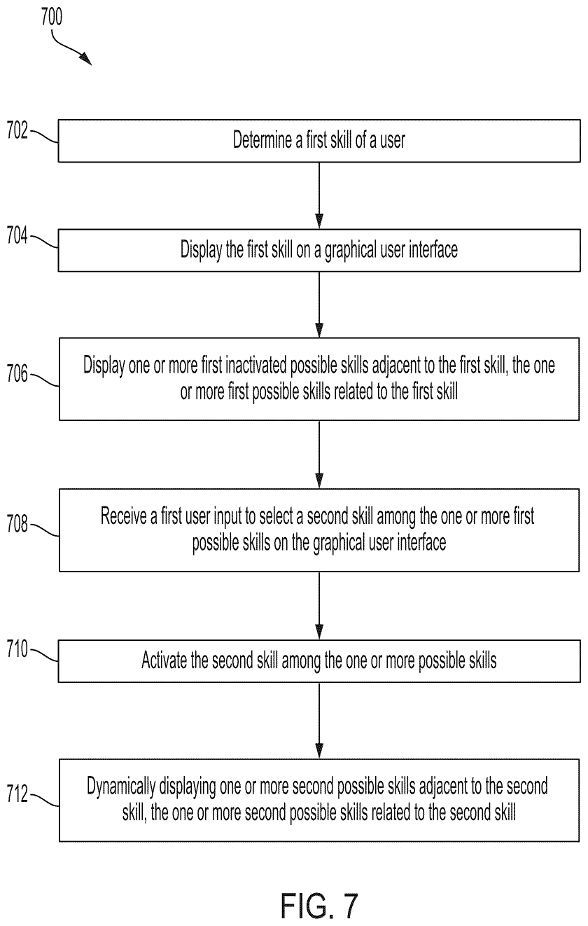

In some aspects of the disclosure, the server 112 in coordination with the database(s) 110 may configure the system components 104 for various skill determination functions, including, e.g., determining a first skill of a user; identifying a job type associated with the first skill family including the first skill and the one or more skills; determining a plurality of parameters corresponding to a plurality of directions on the graphical user interface; determining the one or more first possible skills related to the first skill based on the one or more parameters of the plurality of parameters; activating the selected possible skill among the one or more first possible skills to be a second skill; determining the one or more first possible skills related to the first skill based on a quantified characteristic of the user; and/or identifying one or more subskills associated with the second skill to acquire the second skill. For example, the system components 104 may be configured to implement one or more of the functions described below in relation to FIG. 7, including, e.g., blocks 702 and/or 710.

In further aspects of the disclosure, the server 112 in coordination with the database(s) 110 may further configure the system components 104 for various transceiving functions, including, e.g., receiving a first user input to select a possible skill among the one or more first possible skills on the graphical user interface; and/or receiving a second user input to select the second skill. For example, the system components 104 may be configured to implement one or more of the functions described below in relation to FIG. 7, including, e.g., block 708.

In further aspects of the disclosure, the server 112 in coordination with the database(s) 110 may further configure the system components 104 for various displaying functions, including, e.g., displaying the first skill on the graphical user interface; displaying one or more first possible skills adjacent to the first skill, the one or more first possible skills related to the first skill; in response to the first user input, dynamically displaying one or more second possible skills adjacent to the second skill; displaying one or more skills in a first skill family based on the first skill in a predetermined direction; displaying a first indication of the first skill; displaying a second indication of the second skill; displaying a progress bar of a first skill family; displaying a progress bar of the second skill on the graphical user interface; displaying one or more learning course contents to acquire the second skill; displaying one or more learning course content completion marks corresponding to the one or more learning course contents; displaying a progress bar including the one or more learning course content completion marks to indicate how many learning course contents of the second skill are completed; magnifying the one or more learning course contents; magnifying the graphical user interface including the second skill; displaying skill information of the second skill; and/or displaying a first indication of the second skill. For example, the system components 104 may be configured to implement one or more of the functions described below in relation to FIG. 7, including, e.g., blocks 704, 706, and/or 712.

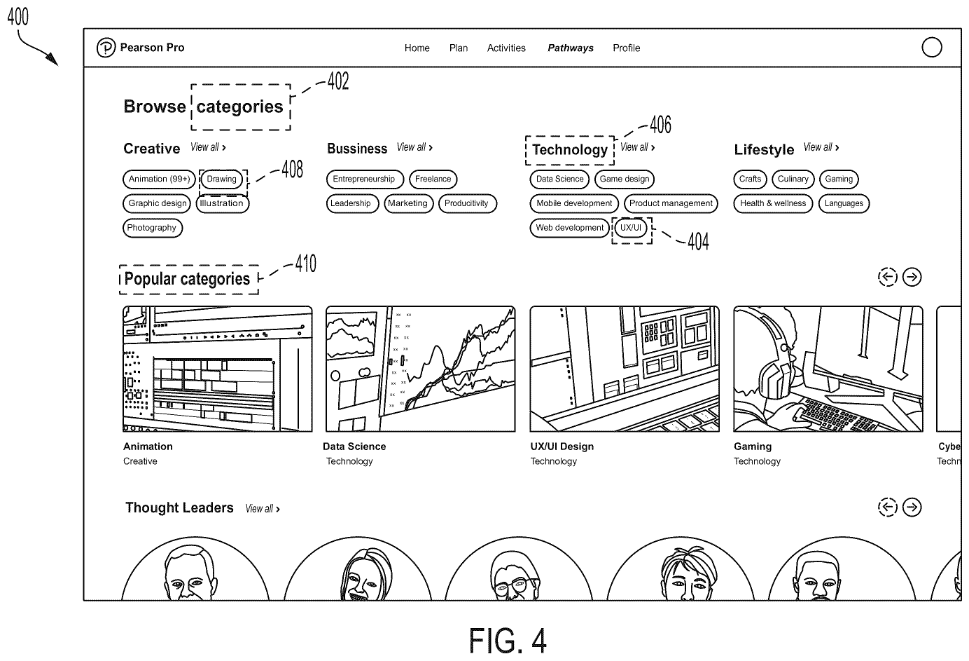

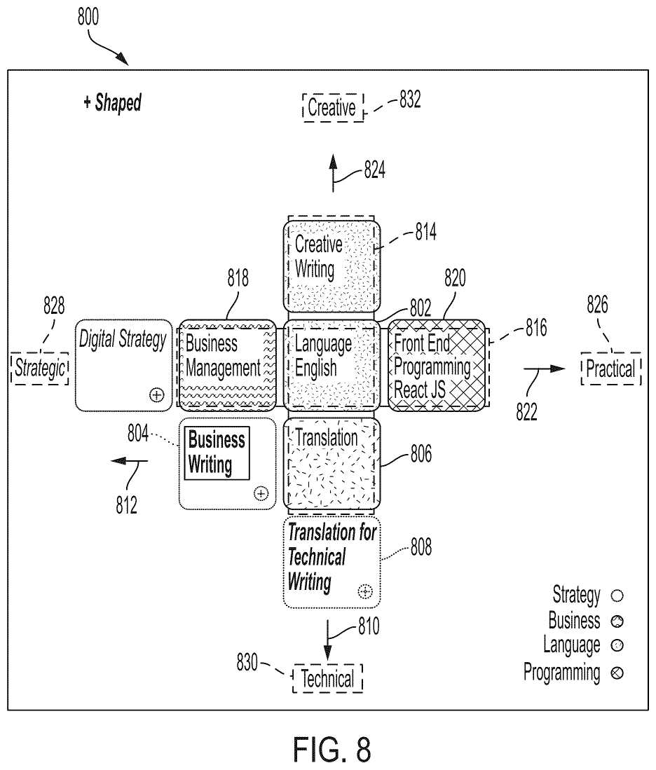

FIG. 4 is a schematic diagram conceptually illustrating an example screen 400 of a GUI for displaying skill families, in accordance with various aspects of the techniques described in this disclosure. For example, the server 102 may generate a GUI screen 400 to be shown on client devices 106 for users via the client devices 106 to explore skill families 402 (e.g., “Categories”). In some examples, a skill family may be a group of skills that are competencies to perform certain tasks in a job. In some examples, a skill family 408 may be included in one or more group families 406. Also, a group family 404 may be included in another group family 406. For example, the server 102 may show “UX/UI” group family 404 as a group family. “UX/UI” skill family 404 may be a child group family of “Technology” group family and may include “UX design” skill family and “UI design” skill family. In further examples, the skill family 408 may also be included in a different group family. Thus, by providing skill families using a hierarchical tree structure on the GUI screen, the server 102 may provide a concise list of skill families for users to easily explore skill families and find skill families which users are interested in. In some examples, the server 102 may provide a separate list of skill families 410, which are popular to users or are in demand in industries. In other examples, the server 102 may provide a list of skill families 408 customized for each user. In further examples, a skill family 404 may include one or more skills. While the GUI screen 400 provides a top-down approach to find skill families in which users are interested, GUI screens shown in FIGS. 8-14 provide bottom-up approaches to find skill families based on user-acquired skills or potential skills to be acquired.

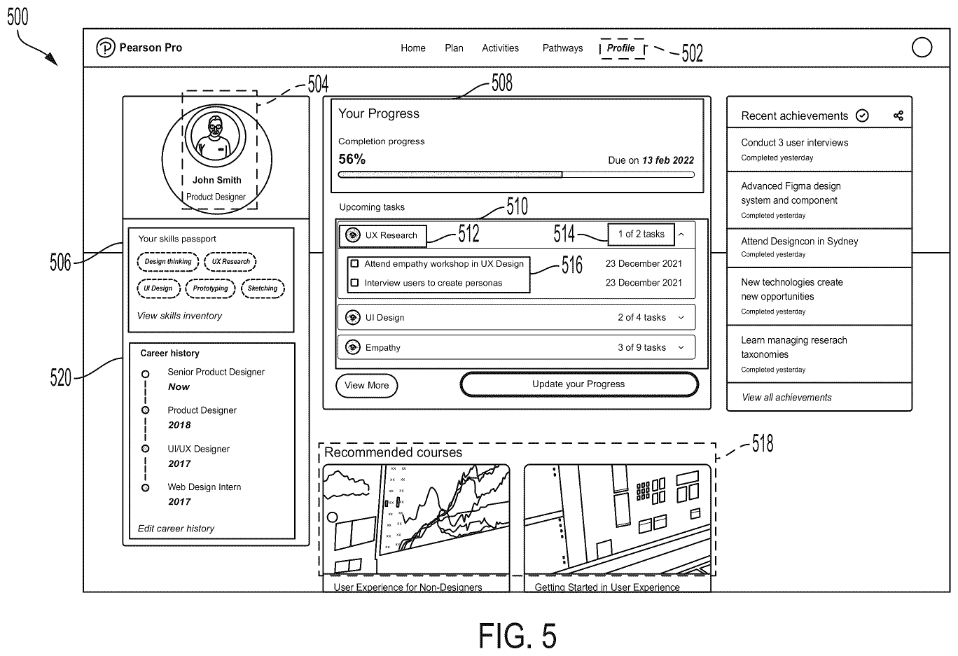

FIG. 5 is a schematic diagram conceptually illustrating an example screen 500 of a GUI for displaying a user profile, in accordance with various aspects of the techniques described in this disclosure. For example, a client device 106 may provide a user's action requesting the server 102 to show a user profile 502. In some examples, the user action may include clicking or selecting a text 502 (e.g., “Profile”) or a symbol on the GUI screen 500.

The user profile screen 500 may include user identification information 504. For example, the user identification information 504 may include, but is not limited to, the name of the user, the picture of the user, and/or the job position of the user. The user profile screen 500 may further include a list of skill families 506 that the user already acquired and/or the user is in process to acquire by taking one or more learning course contents 304. The user profile screen 500 may also include a progress bar 508 to indicate how many skills and/or learning course contents the user acquired and/or how many skills and/or learning course contents the user has yet to complete. In some examples, the progress bar 508 may indicate how many skills and/or learning course contents in a skill family the user acquired. In other examples, the progress bar 508 may indicate how many skills and/or learning course contents in all skill families indicated by the user to acquire. In further examples, the progress bar 508 may also indicate the completion rate of a skill and/or a learning course content.

The user profile screen 500 may also include the status 510 of a skill family, a skill, a subskill, and/or a learning course contents. For example, the user profile screen 550 may display UX Research 512 as a skill family and the status 514 of UX Research 512. The status 514 of UX Research 512 may indicate how many skills or tasks the user acquired or completed. The screen 500 may display a list of skills or tasks 516 included in the skill family and their status. For example, the UX Research 512 as a skill family includes two skills, “attending empathy workshop in UX design” and “interviewing users to create personas.” Then, the screen 500 may display which skills or tasks are completed by the user. The GUI screen 500 may show and hide skills or tasks 516 (e.g., using a dropdown button). It should be appreciated that this is a mere example. For example, the UX Research 512 may be a skill and includes two sub skills or two learning course contents 516. In other examples, the GUI screen 500 may display a list of skill families with their status, a list of skills with their status, and/or a list of learning course contents with their status. In further examples, the GUI screen 500 may display recommended courses 518 associated with the user identification information, a skill family, a skill, and/or learning course content that the user already acquired or completed or intended to acquire or complete. In even further examples, the GUI screen 500 may display the user's career history 520.

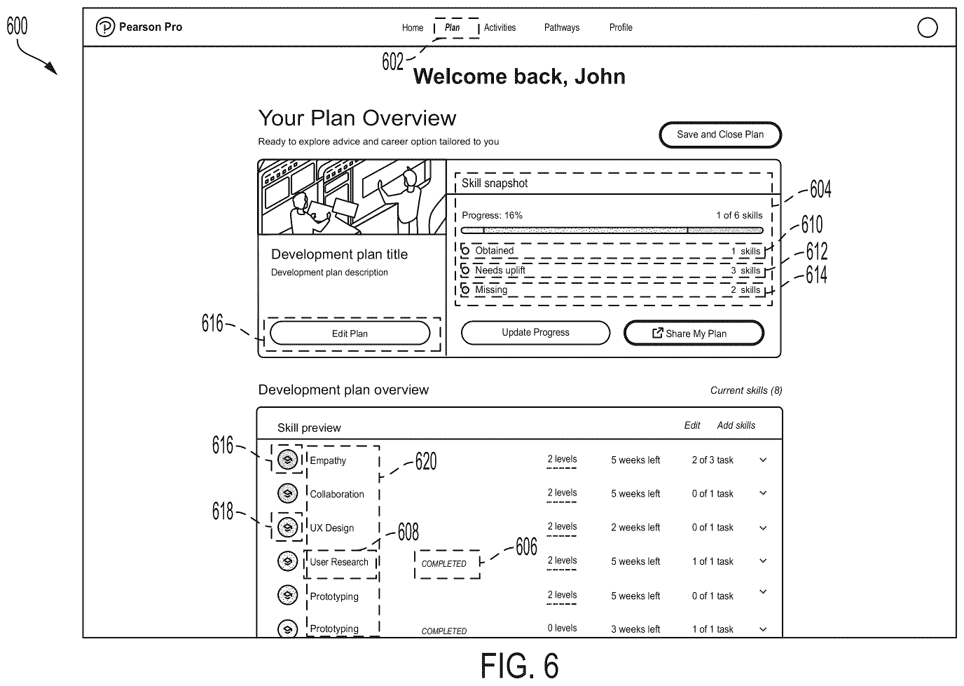

FIG. 6 is a schematic diagram conceptually illustrating an example screen 600 of a GUI for displaying a user plan, in accordance with various aspects of the techniques described in this disclosure. For example, a client device 106 may provide a user's action requesting the server 102 to show a user plan. In some examples, the user action may include clicking or selecting a text 602 (e.g., “Plan”) or a symbol on the GUI screen 600.

The user plan screen 600 may display a progress bar 604. In some examples, the progress bar 604 may indicate how many skills the user acquired, needs uplift by the user, and/or the user intends to acquire. For example, when the user completed all learning course contents in a skill 608, the server 102 may mark 606 (e.g., as “Completed”) that the user acquired the skill. The acquired skill 610 may be reflected on the progress bar 604. In some examples, although a skill 608 is completed, the skill 608 may be shown to be improved and yet require further improvement. For example, a skill (e.g., intermediate business writing) may be associated with another advanced skill (e.g., advanced business writing). Then, the server 102 may display the skill as a skill to be uplifted or improved (e.g., using a text or a symbol on the GUI screen). When the server 102 receives a user's action to select or click the text or symbol of the skill to be improved, the screen 600 may display one or more advanced skills associated with the skill. The one or more skills 612 to be uplifted may be reflected on the progress bar 604. In further examples, there are one or more skills to be completed. For example, when the user did not complete a skill, the server 102 may mark 606 (e.g., as “missing” or “potentially obtain”) that the user has not completed or acquired the skill. The one or more skills 614 to be completed may be reflected on the progress bar 604. It should be appreciated that this is a mere example. For example, the progress bar may be associated with one or more skill families, subskills, and/or learning course contents.

In some examples, the screen 600 may indicate that one or more skills are associated with a skill family. For example, the screen 600 may display symbols with different colors 616, 618 to indicate different skill families. It should be appreciated that this is a mere example. The screen 600 may indicate a skill family including one or more skills in a different way. For example, the screen 600 may show a skill family (e.g., using a drop-down button) to include one or more skills. In further examples, the screen 600 may also display one or more learning course contents to be included in a skill.

In some examples, a user via a client device 106 may construct a list of skills 620 in the screen 600 using a skills map shown in FIGS. 8-14 and/or the process of FIG. 7. The list of skills can be constructed or revised using the skills map, which is elaborated in detail in connection with FIGS. 7-15. For example, the screen 600 may display a button 616, a text (e.g., “Construct Plan” or “Edit Plan”), any suitable symbol to construct or edit a skills map. When the user has not constructed a skills map to include user-specific skills, the screen 600 may display a button 616 to construct a skills map. When the user has constructed a skills map, the screen 600 may display a button 616 to edit a skills map. When the user via the client device 106 selects or clicks the button 616, the server 102 may receive the user's action to select or click the button 616. Then, the server 102 may display another GUI screen to construct or edit the skills map. Constructing an interactive and dynamic skills map is a bottom-up approach contrary to a static top-down approach. That is, the server 102 may allow users to explore and extend to potential skill(s) based on current skills, acquire one or more skill families, and ultimately lead to job options related to acquired skill families or skill families to be acquired. The skills map can be interactively and dynamically changed or adjusted based on already acquired skills, user interests, user preferences, and/or user characteristics.

FIG. 7 is a flowchart illustrating an example method and technique for constructing an interactive and dynamic skills map, in accordance with various aspects of the techniques described in this disclosure. The flowchart of FIG. 7 utilizes various GUI screens that are described below with reference to FIGS. 8-15. In some examples, the process 700 may be carried out by the server(s) 102 and/or the client device(s) 106 illustrated in FIG. 3, e.g., employing circuitry and/or software configured according to the block diagram illustrated in FIG. 2. In some examples, the process 700 may be carried out by any suitable apparatus or means for carrying out the functions or algorithm described below. In some examples, any systems and/or GUI screens are used to implement the flowchart 700. Additionally, although the blocks of the flowchart 700 are presented in a sequential manner, in some examples, one or more of the blocks may be performed in a different order than presented, in parallel with another block, or bypassed.

At block 702, a server (e.g., one or more of the server(s) 102, also referred to as the server 102) may generate, for display on a client device for a user, a graphical user interface (GUI). In an illustrative and non-limiting example, the GUI may include a GUI screen 800 as shown in FIG. 8. FIG. 8 illustrates an example GUI screen 800 for constructing a skills map, which is personalized and customized to the user. The server 102 may determine a first skill of a user. In some examples, the first skill may be a skill that the user already acquired. The server 102 may determine the first skill based on the user profile shown in FIG. 5. In some scenarios, the server 102 may determine the first skill based on user input. For example, the first skill may be determined in user's career history 520, which the user input (e.g., in a data entry step via the client device 106). For example, the server 102 may determine that the user acquired one or more skills (e.g., Web design) while working as a product designer. For example, the server 102 may access one of the databases 110 (e.g., the skills data 306), which may map job titles or functions from a digital resume or job history to one or more skills. Thus, the server 102 may use the job titles or functions as a search query input to the database, which, in response, may output the one or more skills to the server 102. In further scenarios, the server 102 may determine the first skill in a resume, a cover letter, a degree, a certificate, a class the user took, or any other suitable user input regarding user's ability to perform a task. Similarly, the server 102 may extract search query terms from one or more of these user input sources to access the database and receive, in response, the first skill. In some examples, the server 102 may map multiple indications in the user input to one skill. In further examples, the server 102 may recognize that different indications or wording can refer to the same skill. For example, the server 102 may access a database including different words that indicate or map to the same skill. The different words in the database have their corresponding indexes pointing to the same skill. Thus, when the server 102 finds different words in the user input (e.g., a resume, a cover letter, a degree, a certificate, a class the user took, or any other suitable user input), the server 102 may convert the different words into the same skill based on the indexing in the database. In other examples, the first skill may be a skill that the user acquired through completing one or more learning course contents in the first skill. For example, when the user completed an online class, an e-book, and a practice exam to fulfill the first skill, the server 102 may determine that the user acquired the first skill.

At block 704, the server 102 may display the first skill 802 on the GUI screen. In some examples, the first skill may be displayed as a tile on the GUI screen. Although the tile is shown to have a generally rectangular shape, in other examples, the first skill may be displayed as a circle, hexagon, octogen, a branch of a tree, or any other suitable shape to show a skill. In further examples, the first skill may be one of multiple first skills determined in block 702 and displayed in block 704. For example, as shown in FIG. 8, the server 102 may determine five related skills that the user acquired. In some instances, skills are displayed in different colors. Skills with different skill families may be displayed with different colors while skills in the same skill family may be displayed with different contrasts of the same general color. In other words, a color characteristic provides another dimension of information regarding the relationship among the displayed skills. For example, three skills 814 (e.g., “Creative Writing,” “Language English,” and “Translation”) in a vertical direction 810 are displayed with different contrasts of the same general color. The color of three skills 814 may indicate that three skills 814 are in the same skill family (e.g., “Language”). However, three other skills 816 (e.g., “Business Management,” “Language English,” and “Front End Programming React JS”) in a horizontal direction 812 are displayed with different colors indicating that the three other skills 816 are in different skill families (e.g., “Business” skill family for “Business Management” skill 818, “Language” skill family for “Language English” skill 802, and “Programming” skill family for “Front End Programming React JS” skill 820). Thus, the skills map 800 provides a map of skills with at least three dimensions of information regarding the relationship of the displayed skills including: (1) layout position (e.g., adjacent tiles are associated with one another, sharing some common characteristics); (2) layout direction (e.g., tiles vertically adjacent are in the same skills family, while tiles horizontally adjacent are associated through another characteristic, such as both being associated with a same job type); and (3) color (e.g., the closeness in color may indicate the closeness in skills, e.g., based on an overlap in sub-skills, and the general color may indicate a particular category or classification of the skill among a collection of skills). However, it should be appreciated that this is a non-limiting example. The indications of skills and skill families may be in any other suitable means. In some examples, the server 102 may identify a job type associated with a skill family including one or more skills.

At block 706, the server 102 may display one or more first possible skills 804, 808 adjacent to the first skill 806. The one or more first possible skills 804, 808 may be related to the first skill 806. The one or more first possible skills 804 may be inactivated. A possible skill may be a skill that is displayed on the GUI screen 800 but not selected and activated by a user input (e.g., click or selection of the possible skill). Thus, the possible skill is a skill that is not incorporated into a user's plan or education pathway as shown in FIG. 6 (e.g., not included in the list of skills 620). In some examples, that a possible skill is related to a skill may indicate that the possible skill is in the same skill family as the skill. In other examples, that a possible skill is related to a skill may indicate that the possible skill is not in the same skill family as the skill but is associated with the skill in some degree. For example, “Adobe Photoshop” skill is in “design” skill family, and “Adobe Premiere” skill is in “animation” skill family. However, “Adobe Premiere” skill is associated with “Adobe Photoshop” in that both skills share many functions of two software programs and use graphical elements. For example, such a link between skills across skills families may be determined based on the number of shared sub-skills between the skills (e.g., the number of shared sub-skills being above a threshold number). In some examples, the GUI screen 800 may show that a skill 804, 808 is not activated using a color of its tile. For example, an activated or acquired skill 806 is filled with color, while a possible skill 804, 808 is displayed with a line drawing of its tile (here, a dashed-line perimeter of a tile) without a skill color in the tile.

For example, with continued reference to FIG. 8, the server 102 may display “Translation” skill tile 806 as the first skill with a solid color. Then, the server 102 may display “Translation for Technical Writing” possible skill tile 808 below the first skill 806 and “Business Wiring” possible skill tile 804 right next to the first skill 806 having outlines without color within the tiles 804, 808. Here, the “Translation for Technical Writing” possible skill 808 is related to the adjacent skill “Translation” 806. Similarly, the “Business Writing” possible skill 804 is related to each of the skills adjacent to the possible skill 804. Thus, the “Business Wiring” possible skill 804 is related to both the “Business Management” skill 818 and to the “Translation” skill 806. In some scenarios, the outline indicating a possible skill may include a color of the skill without the color within the tile of the possible skill. In further scenarios, the GUI screen 800 may display more than one possible skill 804 in one tile. For example, in the tile 804 adjacent to the “Business Management” skill 818 and the “Translation” skill 806, there could be more than one possible skill related to the two skills 804, 818. Then, the GUI screen 800 may display a list of possible skills in the tile (e.g., using a drop-down menu). Further, the server 102 may determine the order of the list of possible skills to be shown in a tile based on currently acquired skills, potential skills to acquire, the information in the user profile shown in FIG. 5, user indicated-preferences, and/or any other suitable information to determine the order.

In some examples, the server 102 may determine multiple parameters 826, 828, 830, 832 corresponding to multiple directions 822, 812, 810, 824 on the GUI screen 800. Each parameter may be indicative of a characteristic of a skill. In the examples, the server 102 may also determine the one or more first possible skills related to the first skill based on one or more parameters of the multiple parameters. The server 102 may display one or more first possible skills based on the one or more parameters of the plurality of parameters. For example, the server 102 may determine four parameters (e.g., “practical” 826, “strategic” 828, “technical” 830, and “creative” 832) corresponding to four directions 822, 812, 810, 824 on the GUI screen 800. Thus, when the user activates a new skill adjacent to an activated or acquired skill in a certain direction, the server 102 may display one or more possible skills related to the activated or acquired skill based on one or more parameters corresponding to the direction. For example, when the activated skill 806 is “Translation” 806, the server 102 may determine a possible skill 808 (e.g., “Translation for Technical Writing”) on in the technical direction to be technical and determine another possible skill 804 (e.g., “Business Writing”) in the strategic direction to be strategic. In some examples, when a possible skill 804 is between the strategic direction 828 and the technical direction 810, the server 102 may determine the possible skill 804 to be strategic and technical. In an illustrative and non-limiting example, the server 102 may impose different weights based on corresponding directions where possible skills are displayed. For example, when a skill 802 is at the center in the skills map or GUI screen 800, skills towards the strategic direction 812 may have more weights for the strategic parameter 828. Further, skills towards the technical direction 810 may have more weights for the technical parameter 830. When skills are between the strategic direction 812 and the technical direction 810, skills may have both weights on the strategic parameter 828 and the technical parameter 830. Thus, the server 102 may display a possible skill based on weights of the one or more parameters. In some examples, the server 102 may determine the multiple parameters 826, 828, 830, 832 based on currently acquired skills, potential skills to acquire, the information in the user profile shown in FIG. 5, user-indicated preferences, and/or any other suitable information. In other examples, the server 102 may determine the multiple parameters 826, 828, 830, 832 based on user preferred parameters (e.g., explicitly indicated). For example, the user via the client device 106 may indicate multiple parameters for the server 102 to determine possible skills based on the parameters.

In further examples, the server 102 may determine the one or more possible skills 804, 808 based on a quantified characteristic of the user. The quantified characteristic of the user may be obtained by a test (e.g., a career-aptitude assessment, the personality assessment, or any other suitable assessment to quantify the characteristic of the user), an indication by the user, or any other suitable means. The test may be a simple list of questions or a third-party assessment (e.g., the Motivational Appraisal of Personal Potential, the Myers-Briggs Type Indicator, etc.). In an illustrative and non-limiting example, when the quantified characteristic of the user indicates that the user is an introverted person, the server 102 may determine the one or more possible skills 804, 808 to focus on user's thoughts and ideas. In further examples, the server 102 may dynamically display the one or more possible skills based on a change of the quantified characteristic of the user. For example, when the quantified characteristic of the user indicates that the user wants to involve more extroverted skills, skill families, or job types, the server 102 may dynamically display the one or more possible skills reflecting the change of the quantified characteristic of the user.

Accordingly, in block 706, the server 102 may determine a set of characteristics about the first skill (or first skills). The set of characteristics may include one or more of (1) the skills family (or families) to which the first skill (or first skills) belong, (2) subskills/learning course contents associated with the first skill (or first skills), (3) one or more parameters associated with a direction relative to the first skill (or skills) in which the one or more first possible skills will be located, and/or (4) one or more quantified characteristics of the user. The server 102 may then use the set of characteristics to generate a query or queries to access one of the databases 110 (e.g., the skills data 306). For example, the set of characteristics may be quantified into a numerical index that serves as a query term, the set of characteristics may serve as a multi-term query, or the set of characteristics may serve as respective queries in a multi-step search function (e.g., each step narrowing the results based on best match criteria). In response to the query, the server 102 may receive from the databases 110 the one or more first possible skills. In other words, the set of characteristics may be used in various ways by the server 102 to determine matches or best matches in a database of skills to identify the one or more first possible skills.

At block 708, the server 102 may receive a first user input to select a possible skill 804, 808 among the one or more first possible skills 804, 808 on the GUI screen 800. For example, the client device 106 may receive the first user input and transmit the user input to the server 102. In some examples, the first user input may indicate, but is not limited to, a mouse click on the second skill 804, 808, a touch on the GUI screen, a voice instruction, a text instruction, or any other suitable input to select the second skill 804, 808.

At block 710, the server 102 may activate the selected possible skill 804, 808 among the one or more first possible skills to be a second skill. In some examples, on the GUI screen 800, activating the selected possible skill 804, 808 may indicate that a possible skill tile without a color is filled with a color indicating a skill. For example, when the activated or user acquired first skill 806 is “Translation” skill 806, the server 102 may determine one or more adjacent possible skills 804, 808 with tiles without color. When the user selects a possible skill 808 among the one or more possible skills 804, 808 (e.g., via user input at the client device 106), the server 102 receives the user input. Then, the server 102 may activate the possible skill 806 and fill the possible skill 806 with a color to be a second skill 806. In some examples, when a possible skill 806 is activated, the activated skill becomes part of a user's plan or education pathway as shown in FIG. 6. For example, the server 102 may add the activated skill to the list of skills 620 and factor the activated skill into the progress bar 604. In other examples, the server 102 may not apply the active skill to the user's plan. But, when the user confirms a constructed skills map (e.g., using a button to finish a skills map), the server may apply all activated skills to the user's plan or education pathway.

In some examples, the server 102 may display an indication of whether the user acquired a skill on the GUI screen 800. For example, the server 102 may display a first indication of the first skill 806. The first indication may be indicative of user's acquisition of the first skill 806. The indication may include, but is not limited to, a mark, a text, a symbol, or any other suitable indication to show acquisition of the skill. Also, the server 102 may display a second indication of the second skill 808. The second indication may be indicative of user's potential acquisition for the second skill 808. The second skill may be in the user's plan but has not been completed. The indication may include, but is not limited to, a mark, a text, a symbol, or any other suitable indication to show that the skill has not been completed. In some examples, the server 102 may dynamically display the first or second indication on the second skill and/or the second indication on possible skills.

At block 712, the server 102 may dynamically display one or more second possible skills adjacent to the second skill in response to the first user input. The one or more second possible skills may be related to the second skill. The server 102 may determine the one or more second possible skills using similar techniques as described above with respect to block 706. In some examples, a possible skill of the one or more second possible skills may be related to the first skill. Thus, the server 102 may provide a graphical user interface for a client device 106 that enables a user to define, visualize, track, and traverse a user-customized career pathway based on currently acquired skills, skills that the user is interested in acquiring, and/or user characteristics. The graphical user interface, and underlying backend system, provides additional and improved functionality relative to online or digital skills improvement systems that use top-down approaches to skills identification; skills identification disassociated from online training systems (and vice versa); and cluttered, complex, and unintuitive displays of skills and groupings of skills, among other benefits.

In some examples, the user via the client device 106 may select or click a button to submit the skills map generated using the process 700. Then, in response to the user action to select or click the button, the server 102 may apply activated skill(s) to the user plan or education pathway shown in FIG. 6. For example, the server 102 may add the activated skills of the skills map displayed on the GUI to the list of skills 620 and factor the activated skill into the progress bar 604. In other examples, when the user activates skill(s) by selecting or clicking possible skill(s), the server 102 may immediately apply the activated skill(s) to the user plan or education pathway. However, the user may revise the skills map by deactivating activated skills and activating other possible skills.

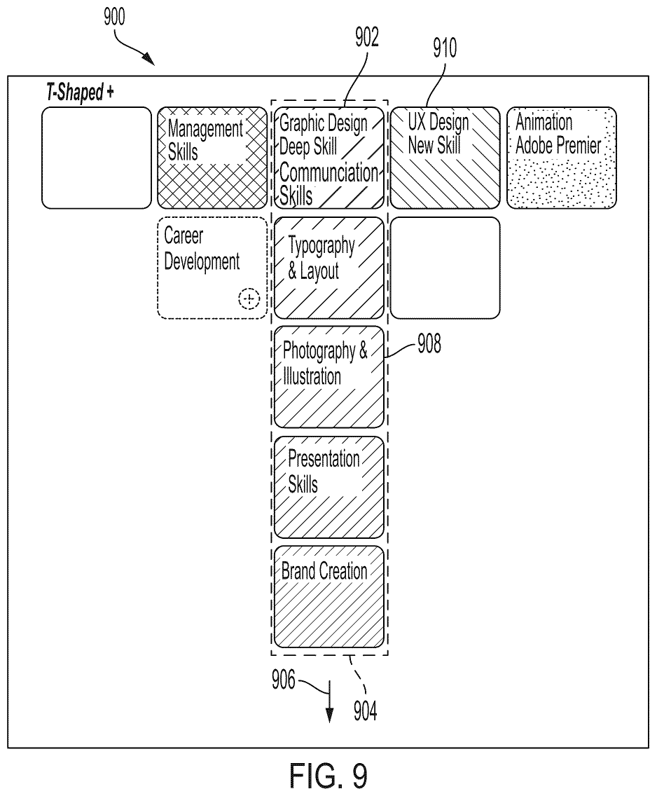

FIG. 9 illustrates a further example GUI screen 900 for constructing a skills map, which is personalized and customized to the user, in accordance with various aspects of the technique described in this disclosure. The GUI screen 900 may incorporate similar functionality as the GUI screen illustrated in FIG. 8, as described above, as well as additional features, which are described in further detail below.

In FIG. 9, the server 102 may determine and display a first skill 902 of a user as described at blocks 702 and 704 of FIG. 7. The first skill 902 may be in a first skill family 904. In addition, the server 102 may further display one or more skills in the first skill family 904 based on the first skill in a predetermined direction 906. In some examples, the predetermined direction may be a vertical direction. For example, the server 102 may determine and display a user-acquired skill (e.g., Graphic Design Deep Skill “) as the first skill 902 on the GUI screen 900. The server 102 may also identify other skills (e.g., “Typography & Layout,” “Photography & Illustration,” Presentation Skills,” and “Brand Creation”) in the same family 904 as the first skill 902. The server 102 may display the identified other skills in the vertical direction. However, it should be appreciated that the predetermined direction may be any other suitable direction.

In some examples, when the server 102 displays the other skills in the same family 904, the server 102 may activate the other skills and display the other skills with color. For example, the first skill family 904 is displayed as a first color, and each of the one or more skills 908 is displayed with a different color contrast of the first color 902. In other examples, the server 102 does not activate the other skills and display the other skills without color as possible skills. In further examples, the server 102 may identify a job type associated with the first skill family 904 including the first skill 902 and the one or more skills 908. Thus, the user may see all skills or at least part of a skill family based on user acquired skill(s). Also, the user may see a list of skills in the GUI screen 900 that is associated with a job type based on the user acquired skill(s) and construct a career path suited to each user.

In further examples, a skill 908 of the one or more skills displayed at a lower region than another skill 902 of the one or more skills on the GUI screen 900 may be more granular than another skill 902. For example, the first skill is Graphic Design Deep Skill 902, and a skill 908, created based on the first skill and displayed lower than the first skill 902, is a more specific skill (“Photography & Illustration”) than the first skill 902 (“Graphic Design Deep Skill”). In even further examples, a second skill 910 may be horizontally adjacent to the first skill 902, and the second skill 910 is in a second skill family, which is different from the first family 904.

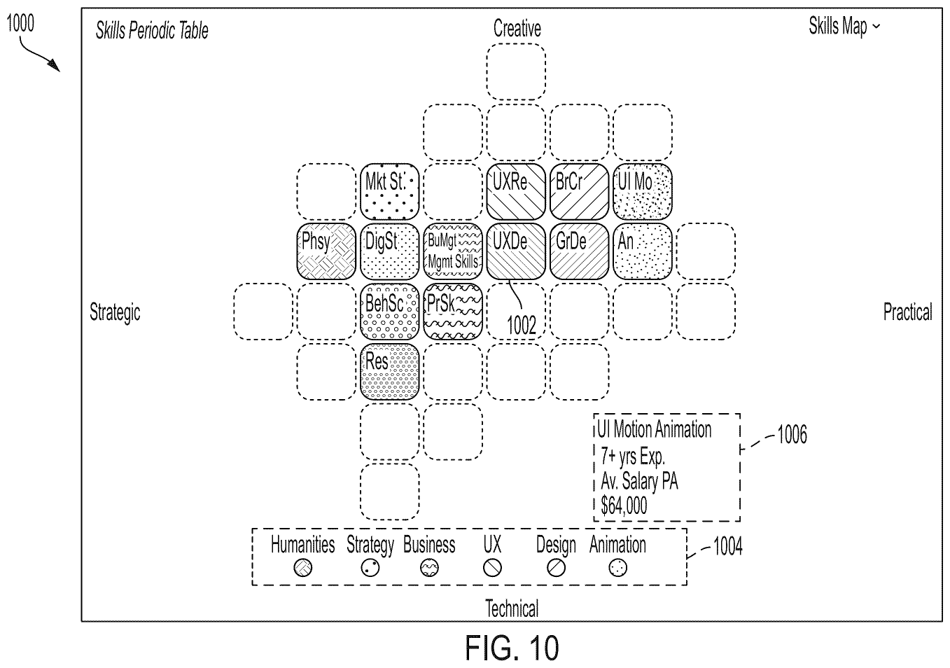

FIG. 10 illustrates a further example GUI screen 1000 for constructing a skills map, which is personalized and customized to the user, in accordance with various aspects of the technique described in this disclosure. The GUI screen 1000 may incorporate similar functionality as the GUI illustrated in FIG. 8, as described above, as well as additional features, which are described in further detail below.

In some scenarios, the server 102 may magnify or shrink the skills map displayed on the GUI screen 1000 in response to a user action. For example, when the user via the client device 106 may shrink the skills map, the GUI screen 1000 may display the skills map with small tiles with abbreviated texts indicating corresponding skills. In an illustrative and non-limiting example, the GUI screen 1000 may display “UX Design” skill 1002 as “UXDe” when the user via the client device 106 makes the skills map small. In some examples, the server 102 may display skill families in different colors on the GUI screen 1000 and indicate the skills families and their corresponding colors in a region 1004 of the GUI screen 1000. In further examples, the server 102 shows information of a job associated with a skill or a skill family that the user selects in another region 1006 of the GUI screen 1000.

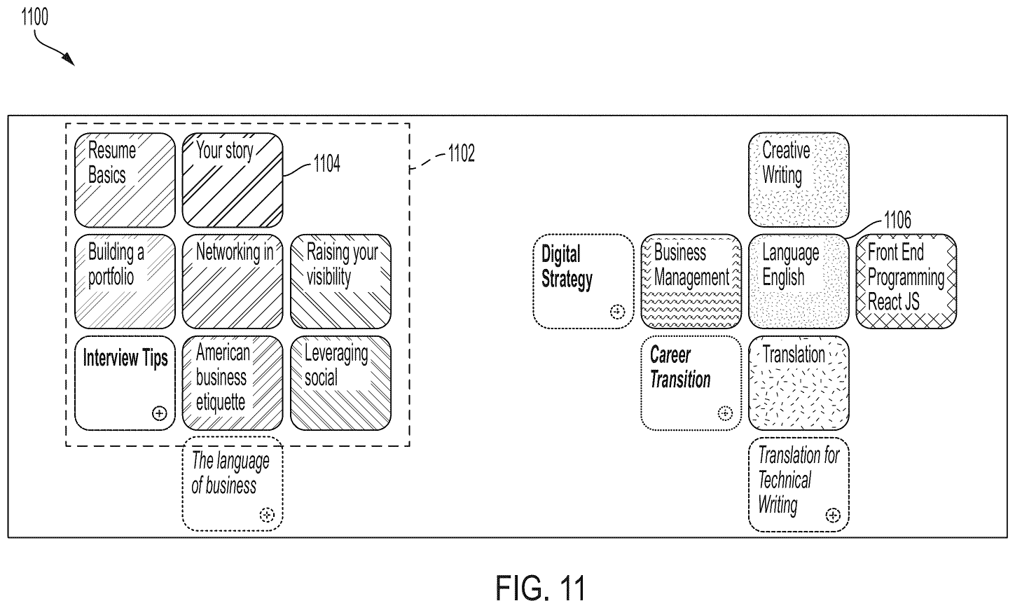

FIG. 11 illustrates a further example GUI screen 1100 for constructing a skills map, which is personalized and customized to the user, in accordance with various aspects of the technique described in this disclosure. The GUI screen 1100 may incorporate similar functionality as the GUI illustrated in FIG. 8, as described above, as well as additional features, which are described in further detail below.

In some scenarios, the server 102 may display a set of skills for a specific skill family or a specific purpose in a separate region 1102 on the GUI screen 1100. For example, the server 102 may display a set of skills (e.g., “Resume Basics,” “Building a Portfolio,” “Networking,” “Business Etiquette,” “Interview Basics,” etc.) to get a new job. In some scenarios, the server 102 may provide a separate tile for introducing the skill family including skills adjacent to the separate tile. In the example above, the server 102 may display an introduction skill tile (e.g., “Your Story”) on the GUI screen 1100 to explain each skill in the skill family to get a new job.

In further scenarios, the server 102 may determine multiple unrelated skills 1104, 1106 that the user acquired. Then, the server 102 may display the multiple unrelated skills in different places that are not adjacent each other on the GUI screen 1100.

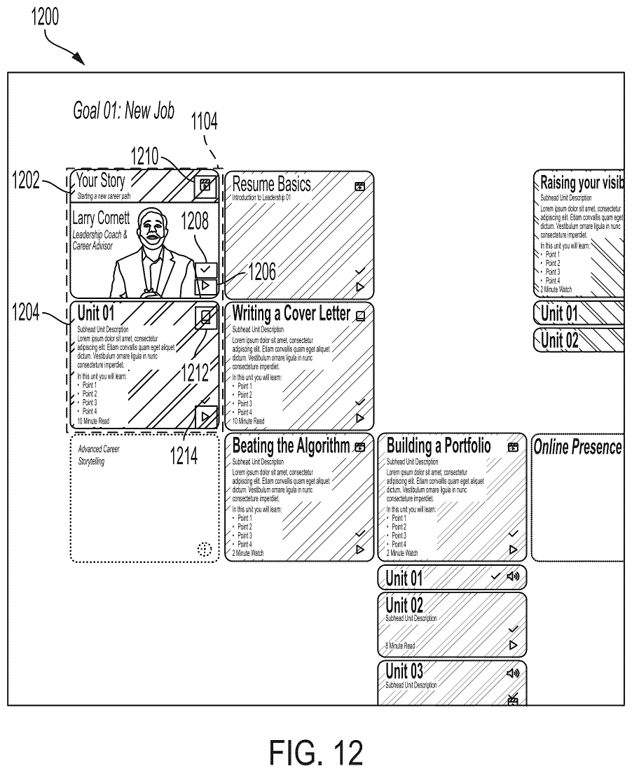

FIG. 12 illustrates a further example GUI screen 1200 for a magnified skills map, in accordance with various aspects of the technique described in this disclosure. The GUI screen 1200 may incorporate similar functionality as the GUI illustrated in FIG. 8, as described above, as well as additional features, which are described in further detail below.

In some scenarios, the server 102 may magnify the skills map and provide detailed information of skills on the GUI screen 1100. The detailed information of a skill may include an explanation of the skill, one or more learning course contents, etc. In further scenarios, the server 102 may display one or more subskills in a skill in the magnified skills map. Thus, the server 102 may indicate that the skill is completed and acquired when all the one or more subskills are completed. In other scenarios, when a skill 1104 includes multiple learning course contents 1202, 1204, a learning course content may include the name of the skill 1104, the heading/subheading of the learning course content, an indication of the type 1210 of learning course content, a summary of the learning course content, the content itself of the learning course content, and/or any other suitable information. For example, when a skills map is magnified, “Your Story” skill 1104 in FIG. 11 may include two learning course contents 1202, 1204. A first learning course content 1202 in “Your Story” skill 1104 may include a video (i.e., content). In some examples, the video (e.g., short-form video) can be played in the skills map when the user selects or clicks the video or a button 1206 on the GUI screen 1200. In other examples, the server 102 may display another GUI screen to perform the first learning course content 1202 (e.g., the video). When the user completes the first learning course content 1202, the server 102 may show a mark 1208, a symbol, a text, or any other suitable indication that the user completes the first learning course content 1202 on the first learning course content 1202. In the examples, “Your Story” skill 1104 may also include a second learning course content 1204. The second learning course content 1204 may include an e-book. The second learning course content 1204 may provide a symbol indicating that the second learning course content 1204 is an e-book. The second learning course content 1204 may also provide a button 1214 for another GUI screen to provide the e-book.

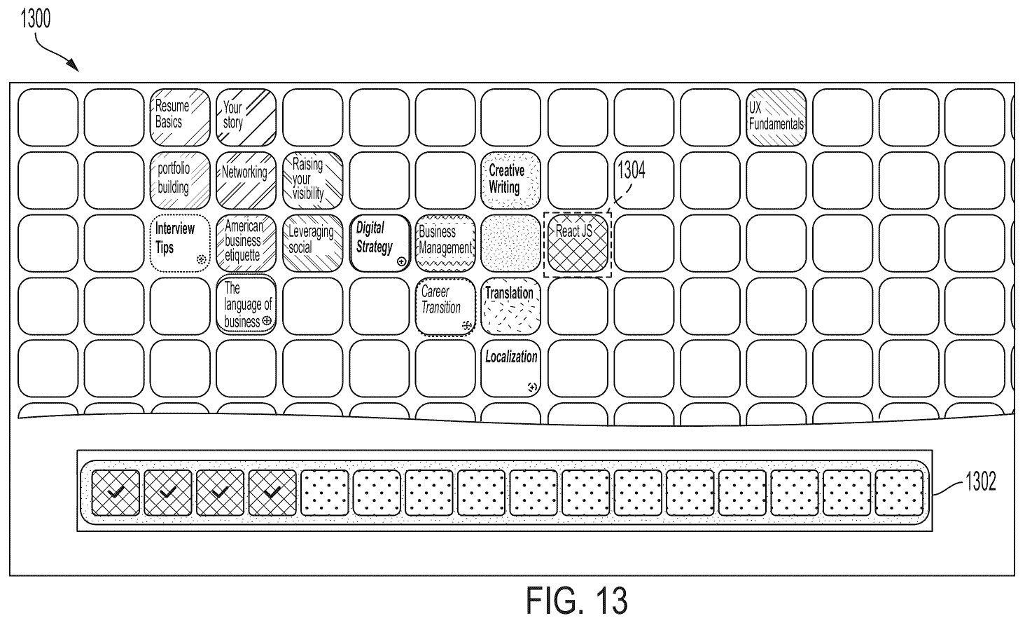

FIG. 13 illustrates a further example GUI screen 1300 for a skills map with a progress bar 1302, in accordance with various aspects of the technique described in this disclosure. The GUI screen 1300 may incorporate similar functionality as the GUI illustrated in FIG. 8, as described above, as well as additional features, which are described in further detail below.

In some examples, the server 102 may display a progress bar 1302 of a skill 1304 on the GUI screen. Here, the progress bar 1302 may indicate user's progress to acquire the second skill 1304. The progress bar 1302 may have the same color as the skill 1304 to indicate that the progress bar 1302 is for the skill 1304. In some scenarios, the skill 1304 may include one or more subskills. Thus, when the server receives a user input to select the skill 1304, the server 102 may display one or more subskills of the skill 1304 and display one or more subskill completion marks corresponding to the one or more subskills. The server 102 may display the progress bar 1302 including the one or more subskill completion marks to indicate how many subskills of the skill 1304 are completed. In other scenarios, the skill 1304 may include one or more learning course contents. When the server receives a user input to select the skill, the server 102 may display one or more learning course contents of the skill 1304 and display one or more learning course content completion marks corresponding to the one or more learning course contents. The server 102 may display the progress bar 1302 including the one or more learning course content completion marks to indicate how many learning course contents of the skill 1304 are completed.

In other examples, the server 102 may display a progress bar 1302 of a first skill family. Here, the first skill family may include the first skill, and the progress bar 1302 may be indicative of how many skills in the first skill family the user acquired. In further examples, the server 102 may display a progress bar 1302 for the entire skills map. Thus, the server may display how many skills the user acquired in the entire skills map using the progress bar 1302.

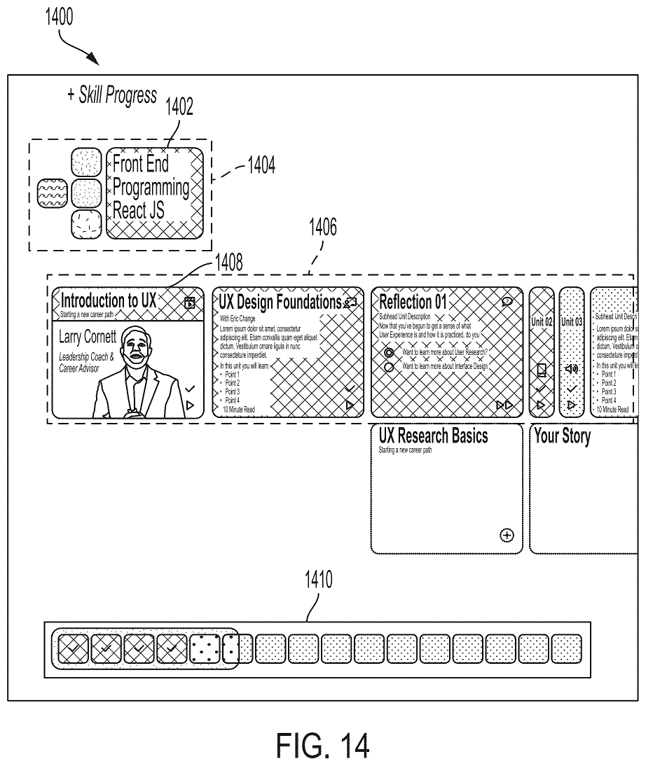

FIG. 14 illustrates a further example GUI screen 1300 for a skills map with a progress bar 1302, in accordance with various aspects of the technique described in this disclosure. The GUI screen 1300 may incorporate similar functionality as the GUI illustrated in FIG. 8, as described above, as well as additional features, which are described in further detail below.

In some examples, the server 102 may receive a user input to select a skill 1402. In some examples, the server 102 may magnify a part 1404 of the skills map and display the part 1404 on top of the GUI screen 1400 in response to the user input. In further examples, the server 102 may magnify and display one or more learning course contents 1406 of the skill 1402 on the GUI screen 1400. In even further examples, the server 102 may display a progress bar 1410 to show how many learning course contents 1406 are completed to acquire the skill 1402. When all the learning course contents 1406 are completed, the server 102 may display a completion mark on the skill 1402 to indicate that the skill 1402 is completed and acquired.

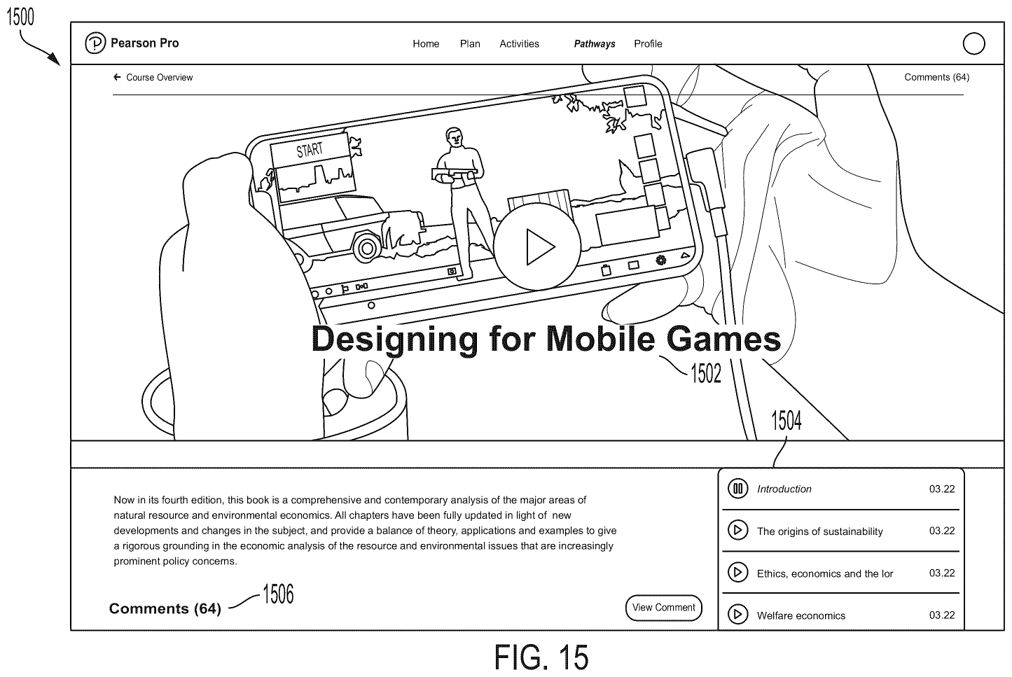

FIG. 15 illustrates an example GUI screen 1500 for a learning course content, in accordance with various aspects of the technique described in this disclosure. The learning course content may include an e-book (electronic version of a printed book), a class (online or offline), a document, a video, a practice exam, a flashcard, an internship, or any other suitable format of learning content in various examples. The GUI screen 1500 may show a video 1502 as an illustrative and non-limiting example of a learning course content. The learning course content 1502 may include a table of contents 1504 and/or comments 1506 for the learning course content. Thus, when all the learning course contents in a skill are completed, the server 102 may indicate that the user acquired the skill. Then, all the skills in a skill family are completed, the server 102 may indicate the skill family. The user can repeat this process until the user acquires all skills in the interactive skills map.

In an example, the systems and methods described herein (e.g., the interactive digital learning platform system 300, the method 700, etc.) enable an efficient technique for managing skills with an interactive and dynamic skills map on a GUI such that the systems may interactively and dynamically build a skills map on the GUI based on user-acquired skills, activated skills, and potential skills. Such interactive and dynamic skills map construction and revision improve the user interface on a client device by preventing the display of undesired or irrelevant skill families, skills, and/or learning course contents and spontaneously providing the display of desired or relevant skill families, skills, and/or learning course contents, in light of the user-acquired skills, activated skills, and potential skills. At the same time, the display of desired or relevant annotations reduces unnecessary battery use of the client device and the network resource usage due to the minimum access to the network.

### Further Examples Having a Variety of Features

The disclosure may be further understood by way of the following examples:

Example 1: A method, apparatus, and non-transitory computer-readable medium for constructing an interactive skills map on a graphical user interface comprises: determining a first skill of a user; displaying the first skill on the graphical user interface; displaying one or more first possible skills adjacent to the first skill, the one or more first possible skills related to the first skill, wherein the one or more first possible skills are inactivated; receiving a first user input to select a possible skill among the one or more first possible skills on the graphical user interface; activating the selected possible skill among the one or more first possible skills to be a second skill; and in response to the first user input, dynamically displaying one or more second possible skills adjacent to the second skill, the one or more second possible skills related to the second skill.

Example 2: The method, apparatus, and non-transitory computer-readable medium according to Example 1, further comprising: displaying one or more skills in a first skill family based on the first skill in a predetermined direction, wherein the first skill is in the first skill family.

Example 3: The method, apparatus, and non-transitory computer-readable medium according to any of Examples 1 or 2, wherein the predetermined direction is a vertical direction, and wherein a skill of the one or more skills displayed at a lower region than another skill of the one or more skills on the graphical user interface is more granular than the another skill.

Example 4: The method, apparatus, and non-transitory computer-readable medium according to any of Examples 1-3, wherein the second skill is horizontally adjacent to the first skill, and wherein the second skill is in a second skill family.

Example 5: The method, apparatus, and non-transitory computer-readable medium according to any of Examples 1-4, further comprising: identifying a job type associated with the first skill family including the first skill and the one or more skills.

Example 6: The method, apparatus, and non-transitory computer-readable medium according to any of Examples 1-5, wherein the first skill family is displayed as a first color, wherein each of the one or more skills is displayed with a different color contrast of the first color.

Example 7: The method, apparatus, and non-transitory computer-readable medium according to any of Examples 1-6, further comprising: determining a plurality of parameters corresponding to a plurality of directions on the graphical user interface, each parameter indicative of a characteristic of a skill, wherein the one or more first possible skills are displayed based on one or more parameters of the plurality of parameters.

Example 8: The method, apparatus, and non-transitory computer-readable medium according to any of Examples 1-7, further comprising: determining the one or more first possible skills related to the first skill based on the one or more parameters of the plurality of parameters.

Example 9: The method, apparatus, and non-transitory computer-readable medium according to any of Examples 1-8, further comprising: determining the one or more first possible skills related to the first skill based on a quantified characteristic of the user.

Example 10: The method, apparatus, and non-transitory computer-readable medium according to any of Examples 1-9, wherein the one or more first possible skills are dynamically displayed based on a change of the quantified characteristic of the user.

Example 11: The method, apparatus, and non-transitory computer-readable medium according to any of Examples 1-10, further comprising: displaying a first indication of the first skill, the first indication indicative of user's acquisition of the first skill.

Example 12: The method, apparatus, and non-transitory computer-readable medium according to any of Examples 1-11, further comprising: displaying a second indication of the second skill, the second indication indicative of user's potential acquisition for the second skill.

Example 13: The method, apparatus, and non-transitory computer-readable medium according to any of Examples 1-12, wherein the one or more second possible skills are dynamically displayed with the second indication.

Example 14: The method, apparatus, and non-transitory computer-readable medium according to any of Examples 1-13, further comprising: displaying a progress bar of a first skill family, the first skill family including the first skill, the progress bar indicative of how many skills in the first skill family the user acquired.

Example 15: The method, apparatus, and non-transitory computer-readable medium according to any of Examples 1-14, further comprising: displaying a progress bar of the second skill on the graphical user interface, the progress bar indicative of user's progress to acquire the second skill.

Example 16: The method, apparatus, and non-transitory computer-readable medium according to any of Examples 1-15, further comprising: receiving a second user input to select the second skill; and displaying one or more learning course contents to acquire the second skill.

Example 17: The method, apparatus, and non-transitory computer-readable medium according to any of Examples 1-16, further comprising: displaying one or more learning course content completion marks corresponding to the one or more learning course contents.

Example 18: The method, apparatus, and non-transitory computer-readable medium according to any of Examples 1-17, further comprising: displaying a progress bar including the one or more learning course content completion marks to indicate how many learning course contents of the second skill are completed.

Example 19: The method, apparatus, and non-transitory computer-readable medium according to any of Examples 1-18, further comprising: in response to the second user input, displaying a part of the interactive skills map on a top region of the graphical user interface; and magnifying the one or more learning course contents.

Example 20: The method, apparatus, and non-transitory computer-readable medium according to any of Examples 1-19, further comprising: magnifying the graphical user interface including the second skill; and displaying skill information of the second skill.

Example 21: The method, apparatus, and non-transitory computer-readable medium according to any of Examples 1-20, wherein the first skill is displayed as a tile on the graphical user interface.

Example 22: The method, apparatus, and non-transitory computer-readable medium according to any of Examples 1-21, further comprising: identifying one or more subskills associated with the second skill to acquire the second skill.

Example 23: The method, apparatus, and non-transitory computer-readable medium according to any of Examples 1-22, further comprising: displaying a first indication of the second skill, the first indication indicative of user's potential acquisition for the second skill; and in response to completion of the one or more subskills, displaying a second indication of the second skill, the second indication indicative of user's acquisition of the second skill.

Other examples and uses of the disclosed technology will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

What is claimed is:

1. A method for providing an interactive skills map on a graphical user interface, the method comprising:
determining a first skill of a user;
displaying the first skill on the graphical user interface;
displaying one or more first possible skills adjacent to the first skill, the one or more first possible skills related to the first skill, wherein the one or more first possible skills are inactivated;
receiving a first user input to select a possible skill among the one or more first possible skills on the graphical user interface;
activating the selected possible skill among the one or more first possible skills to be a second skill; and
in response to the first user input, dynamically displaying one or more second possible skills adjacent to the second skill, the one or more second possible skills related to the second skill.

2. The method of claim 1, further comprising:
displaying one or more skills in a first skill family based on the first skill in a predetermined direction,
wherein the first skill is in the first skill family.

3. The method of claim 2, wherein the predetermined direction is a vertical direction, and
wherein a skill of the one or more skills displayed at a lower region than another skill of the one or more skills on the graphical user interface is more granular than the another skill,
wherein the second skill is horizontally adjacent to the first skill, and
wherein the second skill is in a second skill family.

4. (canceled)

5. The method of claim 2, further comprising:
identifying a job type associated with the first skill family including the first skill and the one or more skills.

6. The method of claim 2, wherein the first skill family is displayed as a first color,
wherein each of the one or more skills is displayed with a different color contrast of the first color.

7. The method of claim 1, further comprising:
determining a plurality of parameters corresponding to a plurality of directions on the graphical user interface, each parameter indicative of a characteristic of a skill,
wherein the one or more first possible skills are displayed based on one or more parameters of the plurality of parameters.

8. The method of claim 7, further comprising:
determining the one or more first possible skills related to the first skill based on the one or more parameters of the plurality of parameters.

9. The method of claim 1, further comprising:
determining the one or more first possible skills related to the first skill based on a quantified characteristic of the user.

10. The method of claim 9, wherein the one or more first possible skills are dynamically displayed based on a change of the quantified characteristic of the user.

11. The method of claim 1, further comprising:
displaying a first indication of the first skill, the first indication indicative of user's acquisition of the first skill.

12. The method of claim 11, further comprising:
displaying a second indication of the second skill, the second indication indicative of user's potential acquisition for the second skill.

13. The method of claim 12, wherein the one or more second possible skills are dynamically displayed with the second indication.

14. The method of claim 12, further comprising:
displaying at least one of a progress bar of a first skill family, the first skill family including the first skill, the progress bar indicative of how many skills in the first skill family the user acquired or a progress bar of the second skill on the graphical user interface, the progress bar indicative of user's progress to acquire the second skill.

15. (canceled)

16. The method of claim 12, further comprising:
receiving a second user input to select the second skill; and
displaying one or more learning course contents to acquire the second skill.

17-19. (canceled)

20. The method of claim 1, further comprising:
magnifying the graphical user interface including the second skill; and
displaying skill information of the second skill.

21. The method of claim 1, wherein the first skill is displayed as a tile on the graphical user interface.

22. The method of claim 1, further comprising:
identifying one or more subskills associated with the second skill to acquire the second skill;
displaying a first indication of the second skill, the first indication indicative of user's potential acquisition for the second skill; and
in response to completion of the one or more subskills, displaying a second indication of the second skill, the second indication indicative of user's acquisition of the second skill.

23. (canceled)

24. A system for an interactive skills map, comprising:
a database storing the interactive skills map;
a memory; and
a server in communication with the database and including a computing device coupled to a network and including at least one processor executing instructions within the memory which, when executed, cause the system to:
determine a first skill of a user;
display the first skill on the graphical user interface;
display one or more first possible skills adjacent to the first skill, the one or more first possible skills related to the first skill, wherein the one or more first possible skills are inactivated;
receive a first user input to select a possible skill among the one or more first possible skills on the graphical user interface;
activate the selected possible skill among the one or more first possible skills to be a second skill; and
in response to the first user input, dynamically display one or more second possible skills adjacent to the second skill, the one or more second possible skills related to the second skill.

25. The system of claim 24, wherein the at least one processor and the memory further cause the system to:
display one or more skills in a first skill family based on the first skill in a predetermined direction,
wherein the first skill is in the first skill family.

26.-29. (canceled)

30. The system of claim 24, wherein the at least one processor and the memory further cause the system to:
determine a plurality of parameters corresponding to a plurality of directions on the graphical user interface, each parameter indicative of a characteristic of a skill,
wherein the one or more first possible skills are displayed based on one or more parameters of the plurality of parameters.

31.-46. (canceled)
